(19) United States
(12) Patent Application Publication
(10) Pub. No.: US 2026/0350771 A1
(43) Pub. Date: Nov. 5, 2026

(54) INTELLIGENT ENERGY COMMISSIONING SYSTEM AND METHOD

(71) Applicant: Budderfly, Inc., Shelton, CT (US)

(72) Inventors: Jacob Marchinus Boerma, Orange, CT (US); Kurt Andrew Hoffmann, Louisville, KY (US)

(21) Appl. No.: 19/664,983

(22) Filed: Apr. 30, 2026

Related U.S. Application Data
(60) Provisional application No. 63/799,839, filed on May 5, 2025.

(51) Int. Cl. G06T 7/00; F24F 11/49; G06T 7/73

(52) U.S. Cl. CPC G06T 7/0002; F24F 11/49; G06T 7/74

(57) ABSTRACT

A system and method is provided for detecting and validating the configuration of HVAC devices installed at a site based on image data and image recognition. The software and method identifies matched pairs of wiring connections in the image and correlates those identified connections to expected wiring connections based on site information that identifies the HVAC devices and their needed connections.

### TECHNICAL FIELD OF THE INVENTION

The present disclosure relates to systems and methods for verification of energy equipment commissioning using image recognition technologies.

### BACKGROUND OF THE INVENTION

The desire to reduce energy consumption is widespread and there is a continual push to produce more efficient appliances and devices with ongoing improvements to the technology available.

HVAC (Heating Ventilation and Air Conditioning) is no exception and is a major user of energy, typically making up 35% of a building’s energy budget. For this reason, it is an area of focus for energy savings as optimizing energy consumption with HVAC makes one of the largest overall impacts to the energy budget.

New technology has brought many improvements to HVAC devices with increases in efficiency. Today’s air conditioning units are using less than ½ of the energy of those from 20-30 years ago.

That said, optimal efficiency of an HVAC device is also very much dependent on proper installation and setup. A badly configured HVAC unit that runs unnecessarily, while more efficient than yesterday’s units, will consume much more energy than when configured optimally for a given site. Further, the difference to the comfort level of occupants will be negligible it even felt at all.

Modern HVAC devices are complex to adjust and come with a plethora of settings and parameters that can be tied to sensors and controls within the building. Occupancy sensors in multiple zones, thermostats, sunlight detection and humidity sensors all provide inputs to the system and allow for optimal energy efficiency when configured correctly. Controls for variable speed motors, set points for cooling and heating as well as ancillary equipment such as fresh air inlets, powered window blinds, air curtains and directional fans all provide methods that can minimize the need for running the energy intensive HVAC compressors and systems, thus reducing overall energy consumption.

The HVAC device may include a multitude of sensors and controls which must be tuned to a particular site and properly configured for each installation to achieve optimal performance. The ability to properly balance the airflows in a building and to run the units only when necessary are all major factors in the potential savings one can achieve with an efficient HVAC installation.

In environments dense with energy consuming devices such as restaurant kitchens or other machine intensive sites, the proximity of devices to one another will generate heat which also affects HVAC performance and energy consumption. Proper venting, thermostat positioning as well as air curtains or directional fans can be used to minimize the impact of this heat.

Even the strategic timing of device duty cycles to reduce peak energy use thereby reducing the overall energy costs are factors that, when looking at a space and an energy budget holistically can provide energy savings with no changes to the equipment. Peak energy minimization can have a long tail effect in that increased peak usage, increases overall costs for the energy bill for many months, regardless of the energy used in subsequent months. The utility uses these peak measurements to plan for and keep sufficient energy reserves available in order to satisfy its clients whether these reserves are ultimately used or not. These are factored into the energy bills as demand charges and added to the facilities energy bill.

Additionally utility billing rates can vary with multiple factors in various locations, and knowing the billing structure is inherently required to minimize energy costs, above and beyond a simple reduction in energy usage. Some examples include:
a. Demand charges described above, whereby a peak usage affects the overall energy bill usually as a cost per KW of peak demand. This is sometimes also measured in relation to the system wide peaks as coincident peak pricing. In other cases, this can be ratcheted up based on the peak usage measured over a full year.
b. TOU (time of use) charges, whereby various time periods are billed at different rates. Usually expressed as peak, off-peak and occasionally super off-peak. Pushing certain functions into these lower cost windows allows one to reduce costs further.
c. Seasonal pricing charges, where peak usage periods like the height of summer or winter may have higher costs.

To fully make the most of an efficient HVAC system, a background of knowledge of the specific billing model used by the local utility and the holistic energy use at the facility is essential.

Installation and commissioning of the HVAC unit involves various sensors and modes that adds a level of complexity to the setup which may be difficult to grasp by technicians doing the installation. Even experienced technicians may not be up to speed with the latest enhancements and features available. While much can be done by software configuration, there are important aspects to physical wiring and switches that must be set on the unit to utilize the unit and the various modes. The installation of an occupancy sensor that is not wired to the proper location on the unit will do little to nothing to improve the unit’s efficiency. What often happens is that when something is not working during installation, the technician may wire features in a way to remove sensors from operation, for example, wiring the occupancy to power directly to get the unit to operate. While technically this HVAC unit is now operating, the hard wiring around the occupancy sensor will fool the HVAC unit to believe there are occupants in the zone that it is conditioning when there may be nobody there. But, this incorrect hard wired or physically set up feature cannot be then corrected unless a technician is sent back out to fix it.

Yet, this problem may not materialize in an immediately noticeable manner in that the newer HVAC unit may be much more efficient, enough to overcome the incorrect setup. While the unit may have been expected to save 30%, the wrong setup may result in only a 10% savings.

The installations are further complicated by the fact that the wiring schema changes per site depending on the availability of sensors and other equipment used in conjunction with the HVAC unit.

US10823440B2 to Gilette teaches methods for interactive HVAC maintenance interface applies the use of pictures and cameras. Gilette does not teach methods to verify the installation which, when badly configured, may cause equipment damage.

US patent publication US20220307714A1 to Truitt for HVAC devices uses photos to submit readings of analog or digital gauges and verify those photos. Truitt does not disclose verification of wiring or verification of physical setup of the HVAC unit.

US patent 10,959,107 to Priest verifies telecommunication sites remotely using a UAV for a cell site audit.

Finally Canadian patent CA2906287C to Yenni seeks to provide a smart system for servicing air conditioning systems and takes into account variables that impact performance of the HVAC device. Yenni does not teach detecting installation setup or wiring for HVAC systems.

### SUMMARY OF THE INVENTION

It would be beneficial to have a system that verifies hardware settings such as wiring and switches to verify an HVAC device installation. Preferably the system utilizes machine intelligence to validate these installations and adjusts them based on the availability of sensors and other environmental and installation data that is gathered by a preinstall site survey, but remote discovery, and by the installer on site. Because the configurations and settings are often customized per job based on the equipment used and the configuration of the site, even with checklists or instructions, installers can miss settings. A image recognition based software system provides a repeatable and accurate check of settings that can be flexible to adapt to the particular installation of each site that reduces or eliminates errors and can in some cases force accurate and complete installation prior to closing out or considering a job completed within order workflow systems.

The commissioning and setup of a complex set of parameters is verified before deployment and start-up to apply best practices for energy optimization. Photographic information is used to capture physical settings such as connector wiring and switch settings which is in turn validated against known configurations and/or installation requirements for the particular equipment and/or site. Machine learning is used to improve upon settings based on specific site attributes and sensor measurements and installer performance is also tracked.

Example HVAC units or HVAC devices may be used for heating, cooling, heating and cooling, de-humidification, ventilation, filtering or other room environment/air quality control in buildings and may include the devices themselves along with the various sensors and controllers and thermostats that makes up the overall HVAC system comprising a variety of HVAC devices. Some units/devices serve multiple functions whereas others may serve only one. What is desired then is a system and method that can verify the configuration and setup of HVAC units using photographic data from the installer depicting key components of the installation such as wiring connections, connectors, dipswitches, and display parameters on the HVAC device.

What is further desired is a system that can use the input data in conjunction with knowledge about the facility and present an analysis of the photographic data with a go/no-go decision to tell the technician that the site is properly installed before the technician leaves, thus preventing a return visit to the site. This go/no-go decision by the image recognition software system may prevent completion of an installation ticket until verification checks are completed, thus making sure that accurate and complete installation is finished.

Still further desired is a system that can propose changes as feedback to the installer in the case of a no-go or for further optimization of the site before the installer leaves the site.

It is desired to provide a system and method that can provide a visual installation guide to an on-site installer based on knowledge of the system being installed and the known set of environmental variables, location data, available sensors, and devices to aid the installer in making the right connections that will facilitate optimal energy savings for the facility.

It is still further desired to provide a method by which the installation can be verified by the use of photographic evidence of key areas such as connector panels, dipswitches, jumpers, connectors and wiring to ensure that the installation conforms to the expected installation parameters.

It is still further desired to provide a method by which new installations which are not previously known can be entered into a database of photographic information and the system trained with the help of the installer doing the first installation.

If is still further desired to provide a system that allows the installer to override, where appropriate, the installation guidelines and re-train the system by entering a new configuration image, or a secondary image. For example in some cases a model of an HVAC may change, or even within the same model, an internal component such as a connector block may change. In these cases the installer can take a picture and have that picture become a secondary reference to verify the installation accuracy of subsequent installations.

It is further desired to provide a system that can monitor the installation performance of installers and how they adhere to the available recommendations and how many issues are faced during the install or how many no-go sites they have encountered. This data can be used to improve performance or provide training or generally grade installer performance.

Further, the system can work as an RPA (robotic process automation) to help automate information lookup and aid the technician while on the site so as to facilitate installations by showing pictures relative to the site and checking the installers work as he progresses with the install and setup. The RPA system can also benefit from learning about new systems as they are encountered or unexpected changes to a setup, allowing the technician to help train the system for subsequent installs.

It would thus be highly desirable to have a system and method that can improve the installation performance of technicians and reduce errors or faulty installations requiring subsequent truck rolls and return visits to a site to adjust physical wiring or connections.

In one configuration, a system of taking a photo of a wiring connector, dipswitch, control panel face plate or screen, or jumper and sending this via a mobile phone or tablet to a central system is provided. The central system analyzes the photograph against expected wiring on a site and provides feedback on whether the wiring is acceptable or whether changes are needed. The system may also direct the technician to the meaning of the various pins or connection points on a connector to aid with wiring as well as verifying the correct installation.

In yet another configuration, the system provides a recommended installation diagram which the installer can use when first starting the job.

In yet another configuration, the installer can override the system and teach the system in cases where the wiring should be different based on additional characteristics of the site, other available sensors, or controls. The system is able to learn from the overridden commands and can adjust its recommendations in future.

In yet another configuration, the installer can enter images of a new configuration encountered in the installation to train the system with images of the new configuration pointing out specific blocks to identify and which connections are to be places where. There are many image processing libraries available and the system does not depend on any specific image processing library, simply a system that allows recognitions of specific blocks within the image such as connector blocks, dip switches and other wiring connectors is used. Further, for training purposes the ability to have the technician interact with the system by loading an image and subsequently pointing out and annotating the components of the image which are important for the installation. In such cases, senior technicians are generally sent to the sites where the site survey or order BOM indicates a brand new type of system is being installed. The annotation and training of the system will take more time and it is important to get it right or subsequent installations with repeat the same errors.

In yet another configuration, the performance of installers can be provided in report format including the installation time, the number of installations, the number of errors or omissions as well as the number of repeat issues detected by the system. This may also apply to the configuration of new system components where the system is trained to learn from the images entered by the technician. Mistakes in this area can be costly as they can directly affect multiple installations by having subsequent technicians improperly install a system replicating the errors present when the system was trained. The level of training and the complexity of the installation site are all factors, as is the number of similar sites the given installer may have encountered.

Therefore in one aspect an installation verification system for a facility is provided and includes software executing on a computer. The software is configured to receive image data of one or more components of an HVAC system installation comprising HVAC system components including an HVAC unit and at least one sensor. The software identifies a plurality of features in the image data related to wiring connections and/or switch settings by correlating the image data to example image data stored in a storage using image recognition, the example image data associating relative positions of items related to wiring connections and/or switch settings on similar HVAC system installations including similar HVAC units and sensors. Based on the correlation of the image data to the example image data as determined by image recognition, the software identifies actual settings comprising actual wiring settings and/or actual switch settings associated with the HVAC system installation. Said software further determines an installation configuration based on the HVAC system components associated with the facility, the HVAC system components identifying the HVAC unit and the plurality of sensors, the installation configuration identifying one or more expected settings comprising one or more expected wiring connections and/or expected switch settings for the HVAC system components. The software further comparing the expected settings to the actual settings to determine if the expected and actual settings match and said software generating an alert if there are expected and actual settings that do not match, wherein the alert is indicative of where the expected and actual settings do not match.

In certain aspects, the HVAC system components are identified by said software in the image data. In other aspects the software receives data identifying the HVAC system components in order to determine the expected wiring connections and/or expected switch settings. In other aspects the alert includes a display with one or more visual identifications of at least one corrective action to remedy expected and actual settings which do not match. In still other aspects the software receives additional image data related to the corrective action and said software uses the image recognition to determine if the at least one corrective action has been performed. In other aspects the actual wiring settings are identified by determining wire color for a plurality of wired connection of a pair of HVAC system components. In still other aspects the pair of HVAC system components includes a plurality of matched pairs of wired connections and the software comparing the expected settings to the actual settings determines the match if wire colors match for the matched pairs of wired connections.

In still other aspects an image capture system for validation of HVAC device configuration at a site is provided including software executing on a computer and the software is configured to obtain site information which identifies HVAC devices for connection at the site. Each HVAC device includes a plurality of wire connectors and wherein a plurality of pairs of wire connectors, one on each HVAC device, are matched by said software to identify matched pairs of connectors for connection at the site. The software is configured to obtain image data associated with wire connectors of two HVAC devices. The software further associates the image data with a corresponding HVAC device identification and said software comparing the image data to stored image data correlated to the HVAC device identification using image recognition to identify wire connections in the image data. The software further determines if the matched pairs of connectors are each connected by a common wire and said software identifying one or more incorrect connections between matched pairs in order to determine if connection of the two HVAC devices is complete and wherein said software generates an alert based on the incorrect connections and determining that the connection of the two HVAC devices is incomplete.

In certain aspects the alert identifies the incorrect connections if the software determines the connection of the two HVAC devices is incomplete. In other aspects wherein the software is configured to direct placement of the camera relative the wire connectors of each of the two HVAC devices to obtain the image data. In still other aspects the image recognition identifies a plurality of wire colors to match each wire color to one of the matched pairs of connectors such that each wire color corresponds to one of the common wires of the matched pairs. In yet other aspects the image recognition further identifies and verifies one or more wire connections on one of the HVAC devices which relate to a sensor based comparing the image data to stored image data which identifies wires connected to the one or more wire connections related to the sensor. In still other aspects the sensor is identified by the site information and the software determines that connection of the two HVAC devices is complete at least based in part on identifying the wires connected to the one or more wire connections related to the sensor. In still other aspects based on the site information the software determines that connection of the two HVAC devices is complete based on identifying one or more connections of one or more of the two HVAC devices which are not connected.

In yet other aspects a method of using image recognition to validate HVAC device installation at a site is provided including providing software executing on a computer said software configured to preform one or more of the steps of: obtaining images of two HVAC devices; comparing the images with a stored image associated with a HVAC device identifier correlated to each HVAC device, the comparison including image recognition which identifies one or more tags in the stored image which are correlated to the images in order to recognize a plurality of wire connections of the two HVAC devices; identifying matched pairs of wire connections associated with the two HVAC devices and identifying a common wire connected between the matched pairs; comparing the matched pairs to an expected wiring configuration associated with the two HVAC devices determine if the matched pairs are connected according to the expected wiring configuration in order to validate correct installation of the two HVAC devices and wherein if the comparing identifies incorrect wiring of one or more of the matched pairs, said software generating an alert.

In certain aspects identifying a common wire includes identifying wire color in each image the two HVAC devices to correlate that wire color with a corresponding one of the matched pairs. In other aspects the expected wiring configuration identifies wire connections in each of the two HVAC devices which should be wired together and the comparing the matched pairs determines if the wire connections in each of the two HVAC devices are the same connections as the matched pairs. In other aspects the method includes the step of said software identifying and verifying one or more wire connections on one of the HVAC devices which relate to a sensor based comparing the image data to stored image data which identifies wires connected to the one or more wire connections related to the sensor. In still other aspects, based on the site information the software determines that connection of the two HVAC devices is complete based on identifying one or more connections of one or more of the two HVAC devices which are not connected.

While the focus in the descriptions and the examples used herein relate to HVAC devices in particular it should not be construed as limiting in any way. Similar mechanisms to verify wiring on other types of equipment could benefit from a similar system.

Other aspects and features will become apparent from consideration of the following description taken in conjunction with the accompanying drawings.

### BRIEF DESCRIPTION OF THE DRAWINGS

FIG. 1 depicts a functional flow diagram showing interaction between the system, installer and remote facility.

FIG. 2 depicts a functional flow diagram showing management of the installation process.

FIG. 3 depicts a functional flow diagram of the system operating at the installation site.

FIG. 4. Shows an example of switch settings detection on an HVAC device

FIG. 5A. Shows an example of wiring detection on a HVAC unit controller.

FIG. 5B. Shows an example of voltage detection on a HVAC unit controller.

FIG. 5C. Shows an example of wiring detection on a thermostat.

FIG. 6A. Shows the camera adjustment system to get pictures that can be processed

FIG. 6B. Shows the image analysis and matching system to get pictures that can be processed

FIG. 6C. Shows the typical flow of the technician and system interactions, including the training of the system when new components and devices are detected.

FIG. 7. Depicts a sample table of known HVAC unit with a sample of sensors and controls annotated as to how they are wired.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

Example embodiments as described herein improve the accuracy and efficiency of installing and configuring HVAC devices using photographic data and machine intelligence.

The present system and method is preferably used by installers who physically install the connections and run wiring to the available sensors on the site. Data is entered about the facility by the installer and is also pulled from a central system which contains location data such as climate zone which is used to group like facilities for comparative analysis and to aid in recommendations. Additional descriptive data such as the size of the facility, the number of windows, which walls face the sun, and the number of outside walls is also kept in the system and often pre-filled from when the site was surveyed or when the site was accepted for installation. These may be discovered simply by detecting their presence or seeing that they are wired to the existing HVAC systems. Further, the entry of existing sensors on the site is entered as part of the site survey and the entry of to be installed components is done.

Further, the availability of other ancillary equipment and sensors on the site is kept and used for recommendations and to aid in the installation requirements and specified for attachment to the HVAC device. Most traditional sites will at a minimum provide programable thermostats to ensure temperature at various zones based on a schedule. In the example of new installations, the data may come from the BOM (bill of materials) for the new installation which will list the various sensors and HVAC units from which the required connections can be determined.

The system may have information of a variety of sensors to be installed at the site. For example, occupancy, CO2, light and air pressure are but some examples.

Occupancy sensors to adjust or override normal programming based on actual occupancy may also be provided. Typically, the system will provide less cooling if no one is present and more cooling if there are many people in a room.

Co2 sensors as well as baffles and variable speed fans to let in outside fresh air are often employed to ensure proper CO2 content or fresh air.

Air pressure sensors such as manometers to measure differential pressure along with baffles and variable speed fans for make-up air to balance of air pressure in rooms of the facility.

Some facilities may also include enhanced features such as sunlight sensors and controllable electric blinds. Others may also include air curtains and smoke sensors or heat sensors around cooking stations and drive through windows to minimize the impact of these systems with the rest of the facility or surrounding area.

Depending on the site, the number and types of sensors and controls will vary and the appropriate ones must be wired and the unit configured to use these. Configuration may in some cases be software driven but in other cases this is done via dipswitches or jumpers on the connection panels. In many cases, the hardwires connections and switch settings must be set manually on site and cannot be overridden with software. If these are not set correctly, another site visit is necessary.

The data related to the HVAC devices, sensors and other equipment being installed or to be configured is provided to the software which then determines the wiring required and settings needed.

Once the installer has completed the install of the HVAC device, the system can verify the configuration and wiring and provide a recommended set of wiring that should be set based on the information in the central system. For example, knowing which sensors and control systems are present, the system will direct the installer to connect the known wiring to the appropriate connections on the HVAC device.

Once all the wiring is done, the installer takes a picture of key areas of the install such as the connector panel. The system uses the photographic data of connections and verifies this against known configuration using image analysis and machine intelligence. This also serves as an audit trail of the installation and a reference for future diagnosis and analysis and can be used to monitor and grade an installers performance over time.

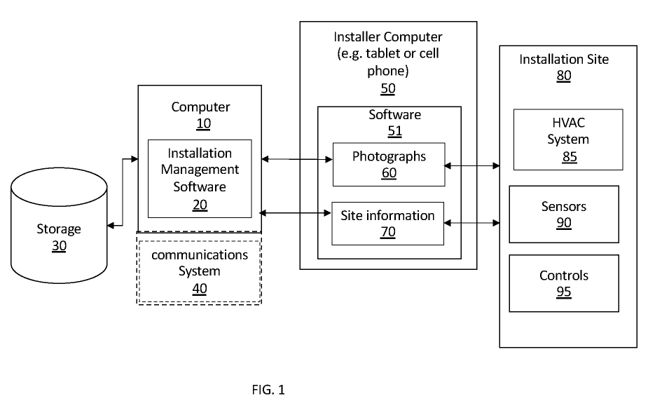

FIG. 1 is a high-level overview of system. A computer 10 runs installation management software 20. The computer 10 is connected to storage 30 and a communications system 40. An installer using a computer tablet or phone 50 with software 51 executing thereon obtains photographs 60 and records site information 70 about an installation site. The tablet 50 also retrieves site information 70 from the central management system 20 to have a comprehensive description of the remote site 80 being installed. The site information indicates which HVAC devices are installed/being installed and connected. This may be various sensors, controllers, wireless adapters/connections, HVAC units themselves (e.g. heaters, air conditioners, air handlers etc). With the site information 70 it is possible to know how the various devices should be wired and configured to work together. The photographs 60 are used to validate such installation.

Installation site 80 is where the installation of the HVAC 85 is taking place and where the HVAC 85 is being configured. The sensors 90 and controls 95 are connected to the HVAC 85 such that it can gather data and control equipment related to the overall HVAC device on site. For example, some sensors 90 include thermostats, occupancy sensors, daylight sensors, humidity sensors, and outdoor temperature measurements, to name a few. Some controls 95 include equipment such as variable speed fans, remotely controllable ducts, and vents. The photographs 60 taken via the installer computer 50 document the configuration post installation and can also be used to validate the site information 70. The photographs 60 and site information 70 obtained from the installation site 80 are provided to the management software 20. In some instances the installer application 51 can prompt the installer to take images of key parts of the installation such as the HVAC device control panel, the thermostat wiring, the portions of the HVAC controller with various dip switch settings etc. The images required can be based on the site information 70 which would indicate which connections need to be checked. Using image recognition, the software 20 identifies the settings and wirings of installed at the site by comparing to known and/or tagged images stored in the storage 30.

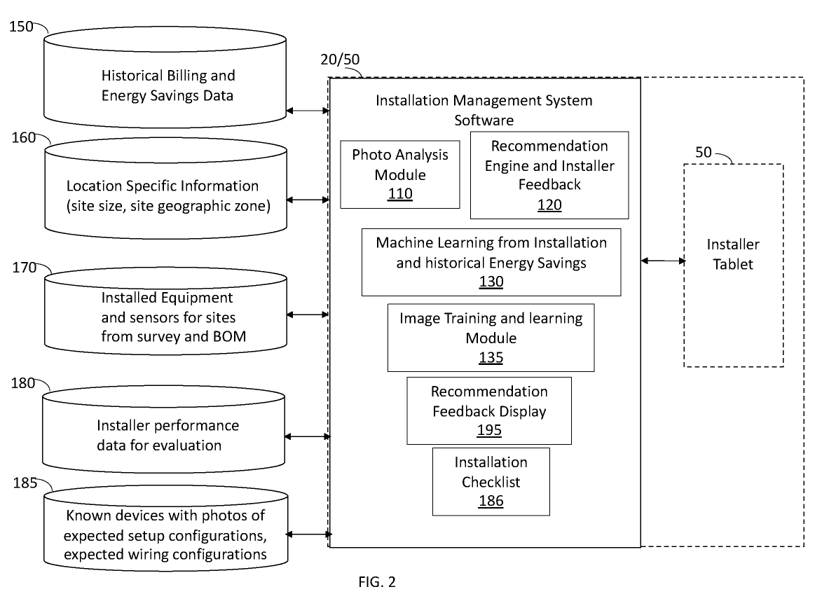

FIG. 2 shows additional details of the installation management system software 20. While individual modules are shown as part of the overall software, this is not intended to limit the structure of the software to multiple separate modules, but is shown to designate feature sets and capabilities of the software. The software is connected to a variety of data sources including historical billing and energy savings data 150 location specific information 160 and site-specific equipment 170 which are used to provide the recommended setup and verify the connections. A database of known configuration types and associated images 185 is used to match the image data gathered by technicians. This database may be configured in the factory based on known setups of equipment used.

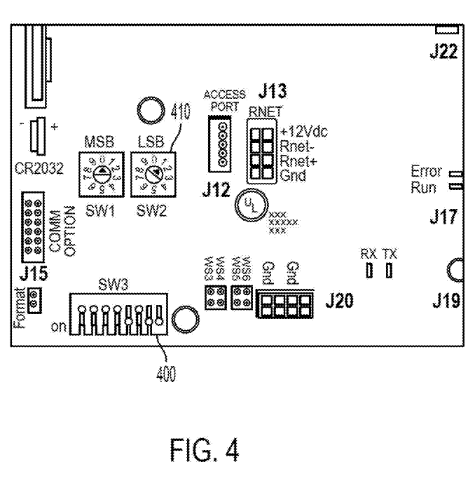

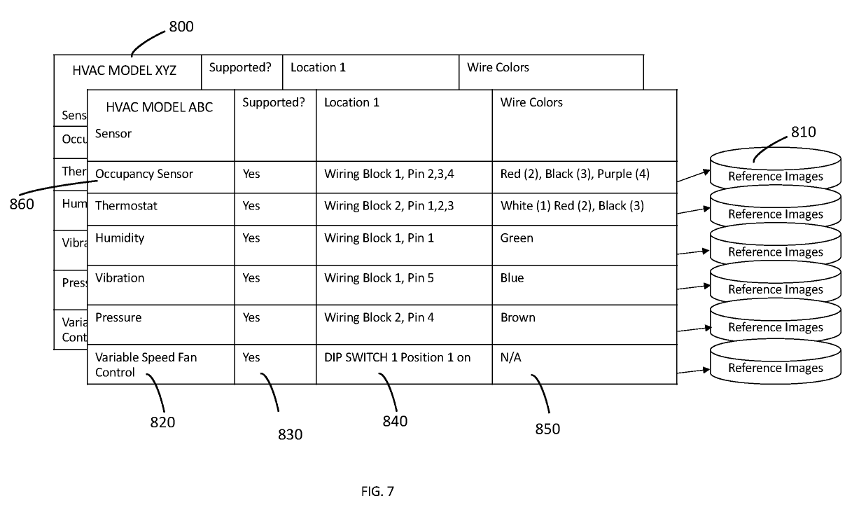

For example, when first training the system, images of the known connector blocks, dip-switches and other configuration blocks necessary for a proper install are taken at the factory. These are stored in the storage 185 as the reference images 810 (See FIG. 7). Each possible configuration can be documented with a known photo whereby the system is trained on how to recognize key components and specific wires or the ranges or settings of the switches can be identified and programmed as options for the photographs to designate different settings. These stored 185 images 810 are tagged with references to indicate markings or features of the equipment of which photos are being taken so that these references can be compared to new photographs. Particularly, the reference images may be taken from a consistent distance and angle of the camera relative to the device, but the installer may not take the image with as repeatable setups. The photo analysis module 110 can recognize this angular and distance based changes by recognizing key static items in the provided images of the install which match the reference photos in the storage 185. By comparing the two, the location of the various switches and wiring connections and their settings can be identified. The reference images may be taken of the wiring connections, dip switches and other physical or on site configurations that can be documented with images. The storage 185 can further contain data about the various images, particularly the range of settings available to correlate with the image tags. This data may be stored in a database or may be stored as meta data of the image itself. The data about the images may designate the available settings of a dip switch in that some switches may have only two positions and others may have three or more. The movement path of the switch may also be indicated, for example rotary or linear. Examples of rotary and linear switches are shown in FIG. 4. The control panel may also have various status lights which may or may not be illuminated and then the wiring component may have a variety of connectors available for use.

As one example, a HVAC device that has a connection for an occupancy sensor that is known to be connected to connector block A position 3. A photo is taken on a workbench of that panel, and the training technician uses the software to point out where the connector block is on the image. Using image processing software, the system separates the block identifying it asking for confirmation. This process is iteratively performed until the training technician confirms that the system has been properly able to detect connector block A. The technician can take multiple images at various angles and sizes now, and test the system to ensure that the connector block a is identified. This type of training may be familiar to some with facial recognition on a phone or image search. Once connector block A is reliably identifiable through multiple image captures, the training technician goes on to train the system about the wiring needed for the occupancy sensor on position 3.

Images are again taken with the wire connected, and not connected training the system to learn when the connection is established. It is conceivable that wiring color can also be used, although in low light areas this may be unreliable and may be turned on or off. Wiring color is not always standard for connections but a company that does the installation may opt to use wire color to ease the connection process for an installer. To illustrate further, take an installation where 5 sensors are connected to the HVAC panel and are run through a wiring harness. Having the system standardize on colors for the various sensors would simplify the identification of the wire bundle coming through the wiring harness. Furthermore, where different colors than standard are used, the system can be used to verify both sides of the connection in that the thermostat wiring image can be taken to identify which colors of wire are connected at which port and then on the controller side for the HVAC device, a wiring photograph can again be obtained to verify that the thermostat wiring connection is connected to the expected port at the HVAC control panel.

Installer data 180 is also stored to evaluate installer performance for factors such as install time, accuracy, errors made, and number of visits.

The installation management system software 20 incorporates a variety of modules or features in its software. The photo analysis module 110 performs image recognition on images obtained via the installer computer 50 to identify wiring connections and switch settings of an installation. A recommendation engine 120 can utilize the site information 70 to provide the installer with suggestions and images for completing the HVAC device installation, the site information may include a variety of information as previously discussed and including the data 160/170 depicted. The machine learning module 130 is provided so that as new photographs are obtained to identify installations and wiring the system can learn from prior views and photos of similar installations to better identify configurations. Furthermore a training module is provided for new configurations 135 whereby the installer can identify a new configuration and/or wiring requirement and take an image of the updated configuration. This may be a new or revised panel or switch configuration or wiring configuration. This updated configuration photograph can then be used to train the system for future installations to allow the system software 20 to recognize future installer photos to verify that updated wiring/configuration for the newer equipment or configuration. A feedback recommendation 195 and installation checklist 186 module are provided to provide the installer with guided installation configurations along with images tagged or annotated with required wiring/settings/configurations. The checklist 186 can be provided to the installer in order to verify settings and operations of the installed equipment. The foregoing can generates information about the specific installation which is sent to the installer tablet 50.

Although the installation management system software 20 is shown on a separate computer from the installer computer 50, it is contemplated that some or all of the functions/modules and features of the installation management software may execute on the installer tablet in whole or in part, thus the dashed lines in FIG. 2 and the designation of 20/50 indicate that the system software may execute on the tablet in whole or in part. For example, the photo analysis module may perform and process the image recognition locally on the installer tablet to identify connections and settings. Furthermore, from the site information, it can be narrowed down which connections and photos the installer should obtain, thus the installer app 51 can be provided with the relevant tagged photos to which the comparison will be made as opposed to the whole collection of tagged photos for all installations/devices. This saves computing power, bandwidth and storage capacity and reduces the time to compare the photos as they are being compared locally. Thus, the site information 70 can drive which photographs the image recognition module 110 compares to on the installer computer 50. The same can be true if the image recognition component executes on the central computer 10 such that based on the site information 70, a subset of the available photos for comparison and image recognition are identified and compared to. The result is a more targeted comparison of only the relevant photos to the particular installation rather than an attempt to identify the HVAC device model from the image so as to then identify the correct tagged image to compare the installer obtained photo to and then perform the recognition process to identify connections and settings.

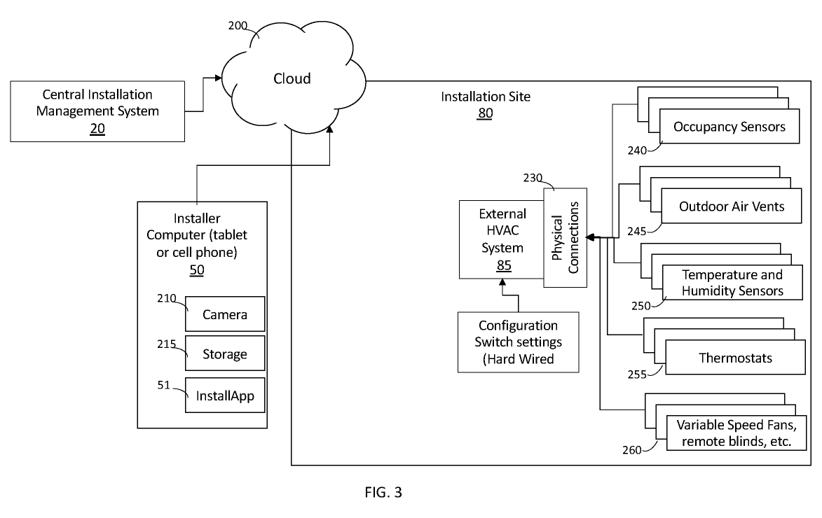

FIG. 3 shows a more detailed breakout of the installation tablet 50 and the HVAC device 85 which are at a given installation site 80. The installer computer 50 is connected to the central management system 20 through the cloud 200. The installation tablet 50 also incorporates a camera 210 storage 215 and an installation application 51 used for the installation and configuration of the HVAC device 85 at a specific site 80. The HVAC device 85 has physical connections 230 which are wired to various sensors such as occupancy 240 temperature and humidity 250 and thermostats 255. The same physical connector 230 is also attached to controllable devices such as outdoor air vents 245 and variable speed fans 260. When configuring a specific site 80, the central system 20 sends expected site specific information to the installer computer 50. The installer computer 50 also takes pictures of the physical connectors 230 and sends these to the installation management system 70. As shown in FIG. 2 the Installation Management System 70 uses a photo analysis module 110 to detect the connector configuration and provides recommendations 120 to the installer through a feedback display 195 and an installation checklist 186.

FIG. 4 shows an example depiction of a photograph taken by an installer after installation. Here a controller board in the HVAC unit is shown with switch settings 400 and 410. The images 60 capture these settings such as on/off or numeric value or position based on image recognition via the installation management software 20 and compares the values detected with the expected settings. Any lights on the board can also be detected and their status such as whether they are on/off or otherwise activated/deactivated in some way to indicate something about the setup of the device.

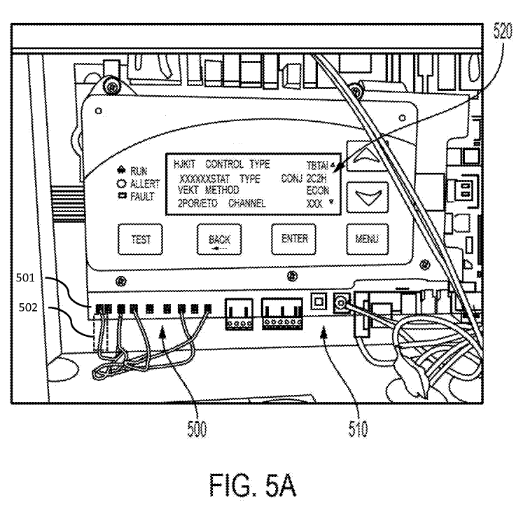

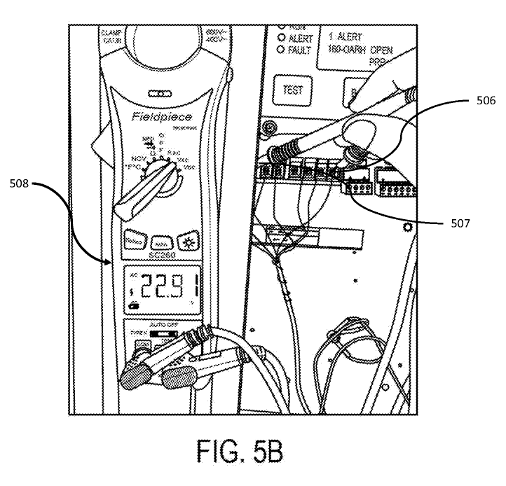

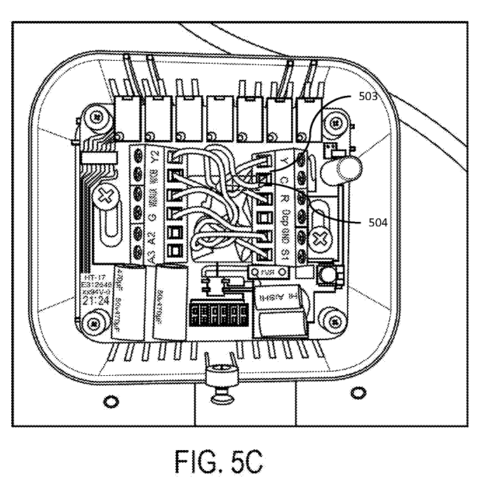

FIG. 5A shows a control panel with an LCD (Liquid Crystal Display) display under which there are a number of connections where wires are to be added from various sensors to a screw in wiring block 500 and to jumpers or connectors 510. The system detects the wired connections 500 as well as plugged in connectors 510 and matches these to the expected sensors at the site to ensure they are plugged in and plugged into the correct locations. The color of the wire can be identified an associated with a particular connection location and this can be cross checked with photos taken of the other end of the wired connection, for example, the underlying sensor or thermostat at the other end of the wired connection. The image recognition 110 in the software 20 can identify if the wire extends all the way out of the box so as to be an external connection or if it is a jumper connection between two or more of the connector screws. The system can also detect visible screen information on the LCD 520 and the technician may be directed to navigate to a given screen using the touch controls on the panel or any lights that are illuminated (or not illuminated). As shown, the wiring area/block 500 includes from left to right connectors R (501), C, Y1, Y2, Y3, G, W1, W2 posts/screws to which wires can be connected. One or more reference images in the storage 185 are tagged to identify these posts/screws and where they should be located, for example relative to other features of or the outline of the panel and then image recognition matches the posts in the uploaded image taken by the installer to that reference image and identifies the wires extending from each post. The installer application 51 can prompt the installer to also take an image showing the voltage 505 between posts/screws so that the image includes a volt meter 508 (shown in FIG. 5B). This uploaded image can identify the readout of the voltage and match it to requirements of the installation. When the image recognition is performed on the uploaded photograph of the control panel wiring (e.g. FIG. 5A), that recognition process can identify the colors of the wires by identifying areas of the image 502, 504 (dashed line) which correspond to a wire and a particular connection 501, 503. The image recognition process may identify pixels that contrast with the background and which are elongated and/or in terms of the color and combinations thereof, for example. Furthermore, the image recognition software is trained to look at the areas 502, 504 of the connectors where wiring connections are expected to be.

While most wiring colors and their related connectors are standardized, there can be some variability in what technicians actually install or what wire colors are available for use. However, to verify installation, an image of the thermostat wiring can also be taken as shown in FIG. 5C. In this case, the image recognition software again identifies wires at the thermostat’s connectors and also identifies the absence of wires. The color of the R wire at the control panel (FIG. 5A) should match the color of the R wire at the thermostat (FIG. 5C). If it does not, the application 51 can return an error to the installer. Furthermore, some thermostats use remote or additional sensors connected thereto and these also need to be wired properly, for example the GND and S1 terminals in the thermostat (FIG. 5C) are for a remote temperature sensor. Based on the site information 70, it is known what connections should be made and which connections should remain open as the site information provides information including the listing of equipment to be installed and the related features, for example, the make and model of the HVAC unit, the make and model of thermostat, any sensors (and if applicable the make and model). From this site information 70, the necessary wiring connections are known and the application 51 can prompt the installer to provide images of key areas of the installation, for example the thermostat and the control panel of the HVAC unit. Image recognition is performed and the colors of the wires and their associated connections on each side are verified. If these pairs of connections, (e.g. the R on the thermostat and the control panel, C, Y1 etc.) should be wired together based on the site information 70, the image recognition software looks to match the wire color on both devices so that the pair of wire connections are matched together by the same color wire. This will indicate that the R connection is wired correctly. The same checking of the pairs can be done for the C, Y1 etc. wire options. In some cases the site information 70 may indicate that wires should not be connected, thus the image recognition software can look for an absence of wires as being the correct state of the matched pair of connections.

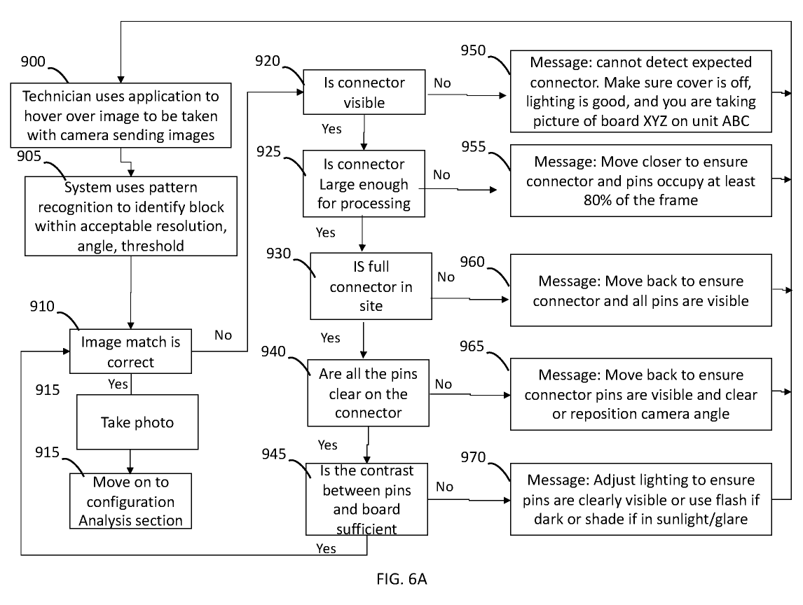

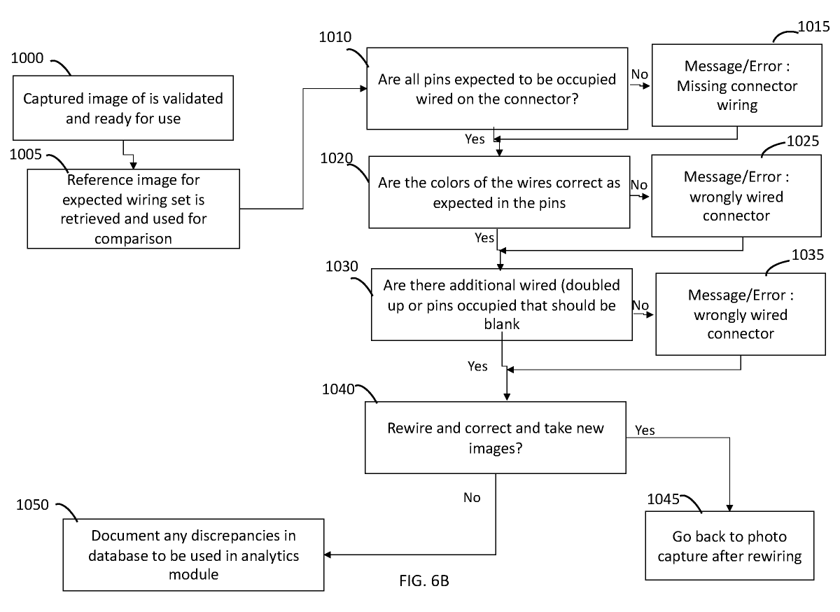

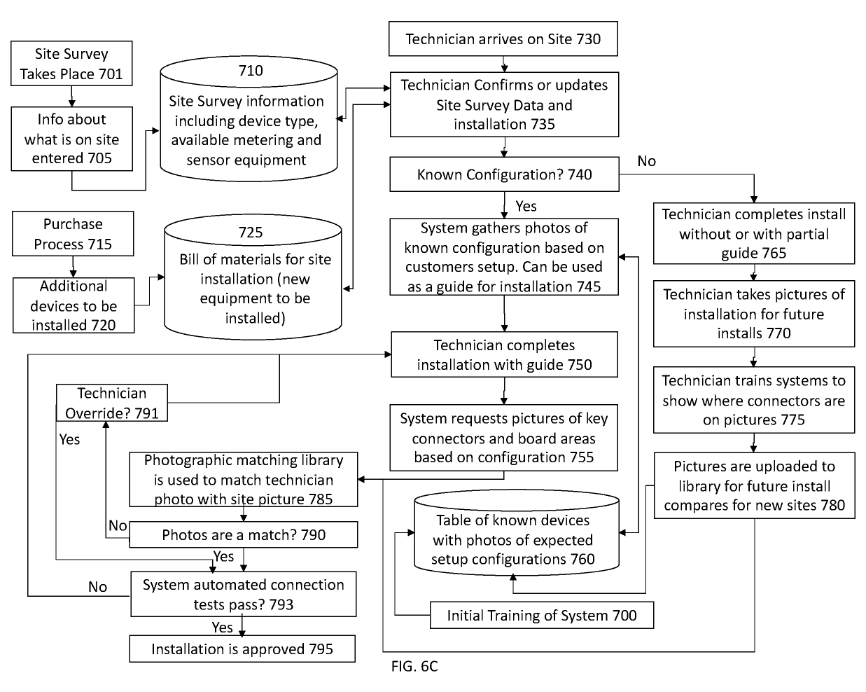

FIG. 6A shows the process by which the installation is accomplished and verified through use of the app 51 and related software 20. The technician uses the smartphone or tablet 50 to take a picture of the connector 900. A connector is used in this example but this could easily be a switch or another piece of configurable hardware on the equipment that the image processing system uses for identification and mapping to expected configuration (one example pair of hardware includes the thermostat and control panel on the HVAC unit). The software on the mobile device (e.g. smartphone/tablet) will instruct/notify the installer/user to take pictures in a particular manner to align the image properly to enable the image recognition software to identify the settings and wiring of the device. The software may have a number of pre-configured image views that are needed to accurately capture the configuration/setup/wiring settings which are based on known features/items of the item which are stationary, for example, known locations of screws, motherboard features and other static elements that indicate or can be used as a reference to determine the positioning/setup of the various switches/wires and other settings/configuration of the units.

The image is passed to the pattern recognition engine 905 and a result is returned on whether the match to the expected connector, in this example, is satisfactory to do the analysis 910. If not an error code is interpreted to ask the technician to adjust the image on his phone. It should be noted that is is done in real time based on the camera position and the system will automatically take the picture when all elements are correct and the image is satisfactory. Alternatively, images can be taken and refused and retaken, but the ability to auto-take the image from the screen and provide guidance to move the camera is ideal. This should not be taken as limiting.

It should be noted here that as part of the initial system programming, the system is configured with reference images of the equipment that is to be used on the site. The system is aware of both the make and model of the RTU system being installed, or previously installed at the site and where the reference connectors are as well as what they look like. These reference pictures have been taken by technicians in the lab and used to train the system as to what these connectors, or other reference components, are. Further, the system knows and has been taught which pins are which wires or connections. This is done by annotating and correctly identifying where the pins are and the orientation of the connector. In some cases, wire coloring can also be used. The orientation may be a marking on the connector itself or a reference component next to the connector (example, a side of the board, and easily recognizable component on the board etc.)

Going back to the process, when the camera is positioned over the connector area, the image information is passed to the application 910 and various checks are done. These checks are dependent on the type of component being verified, in this example a connector.

If the connector is not visible 920 or cannot be found in the image data, a message 950 such as “Message: cannot detect expected connector. Make sure cover is off, lighting is good, and you are taking picture of board XYZ on unit ABC” is displayed as it may be due to various reasons. If he is positioning the camera with bad light, reflections or simply in the wrong spot.

If the connector is not large enough in the frame being captured 925 a message 955 such as “Message: Move closer to ensure connector and pins occupy at least 80% of the frame” is displayed and as the camera is moved the message goes away.

If the connector pins are not visible in the frame 930 a message 960 such as “Message: Move back to ensure connector pins are visible and clear or reposition camera angle” is displayed and as the camera is moved the message goes away.

If the connector is not fully in the frame 940 a message 965 such as “Message: Move back to ensure connector and all pins are visible” is displayed and as the camera is moved the message goes away.

If the contrast or brightness of the image is such that 945 the connector and pin connections is not clear 945 a message 970 such as “If the connector is not fully in the frame 940 a message 960 such as “Message: Move back to ensure connector and all pins are visible” is displayed and as the camera is moved the message goes away.” is displayed and as the camera is moved the message goes away.

In all error cases the image is automatically sampled at a rate that allows the image processing engine to evaluate the image as the camera is moved over the location in question that contained the connector or piece being evaluated.

While the example references a connector, it should be noted that in a similar fashion other components can be trained and learned by the system. Take a POT such as shown in FIG. 4 reference 410. In such a case the image pattern recognition software would identify the LSB pot with multiple reference marks. It would look for the SW3 (400) below it as well as the letters LSB on top and SW2 below as well as a separate pot MSB on the left and the letters J12 on the bottom. Multiple references are used in case letter have faded, or stickers have been put on top. In all cases, the general shape and look of the POT as being a square component with numbers in a circle and a round dial with a line and arrow on it are also instrumental in identifying that the component in question is in fact a pot. The localization reference marks ensure it is the right pot.

In some cases, a board version may also introduce new components in which case new reference images should be included if extensive changes are identified. With the pot 410 example, the system, once having properly identified the POT SW2 410 in FIG. 4 if would look for the line and arrow combination on the round dial between the numbers to identify which number the arrow was pointing to. In the image we can see that it is pointing to the number 1.

As another example from FIG. 4 again this time switch SW3 or reference 400 we use a similar technique to identify and localize the rotary switch. Here the software looks the edge of the board below the switch, the letters SW3 above the dip switch, as well as pins RS3 on the right as well as the letters on the left. Once again, multiple reference marks are used in case some have been faded, covered, or otherwise not visible. The shape and formfactor is also used to identify that the component is actually a dip switch device. And in this case looking for a rectangular unit with 8 switches helps to positively identify the unit.

As with the connector example, in the cases of pots or dip switches we ensure the image contains sufficient clarity and contrast to identify where the pins or dials are. Similar techniques can be used to train the system to identify other configurable components.

Referencing now FIG. 5 and LCD display 520, the camera can be used to capture a display value whether it is the default shown or a screen arrived at with the technician pressing the buttons and navigating the menu. In such cases the screen size and location is used to localize the display and the position in the screen of the data to be captured and analyzed is used.

It is understood to those skilled in the art that these are only a few examples of where the image processing and image recognition system can be used to identify key parts of the installation of the system. On a larger scale it is even conceivable that taking a picture of the unit itself from afar will allow the system to identify the unit being configured by make and model.

It should also be noted and along with the reference equipment which is known to be at the site. The set of sensors and optional equipment that can be used to configure the RTU unit is also known. This knowledge is what allows the system to know which setting are the right ones, which wired should be connected, which rotary swtich settings should be used and which dip switch settings, among other configuration options are to be used. The optional equipment, the site type, site location, and other knowledge about the site allow the system to know the optimal configuration for the system and this forms the basis of the expected result that is matched with the found result derived from the photos.

FIG. 6B shows an image analysis and matching technique for when processing the image and matching it to known and expected images. The captured image that has already been validated 1000 is now matches with the reference image 1005 in the system for a given site. At this point the system knows the site information, the equipment on the site and the sensors which are available to be installed and configured. As such, the reference images along with the site data will provide the information needed for matching the expected configuration with the captured configuration. Again the example used will rely on a connector but this can apply to pots, dip switches, LCD screens and other components that are to be verified as part of the installation and captured. At a high level, even being sure that the equipment installed is the correct equipment can be done in this fashion. A reference image of the RTU unit itself or the serial number back plate, or the model number on the unit can be used as as reference and the technician asked to take a picture of these to confirm the equipment expected at the site is actually at the site. If this proves to be wrong, then updated reference images for the equipment actually installed can be used and discrepancies logged in the database

With the captured image 1000 and the reference image 1005 the system first located the wires pins of the connector to identify if all the wires are populated in the expected locations 1010 and if not an error is shown with a missing wire 1015 describing the location and what is expected.

Installations also rely on wire color to identify the various components and the system checks color 1020 of the wires and if there is a mismatch a message 1025 about wrongly wired connector appears explaining the missing/mismatched colors as an aid to having the technician correct these. The system also traces the wiring connection to ensure that it goes either out the unit where a number of wires meet and are within a common sheath or that the wire is a jumper connection between two or more connector posts (screws). Additional wires detected 1030 are also flagged and shown as 1035 wrongly wired, as these may suggest hard wiring of components such as adding a fan to be always on despite thermostat setting controls.

The technician has the ability to go back and rewire 1040 based on the image analysis 1045 and restart the process taking new images again and redoing the matching and the app may guide this process by identifying or providing alerts or markings where the installation was done incorrectly. The technician can also accept and document discrepancies and add annotations to the installation file as to why these are done. In some cases perhaps an expected sensor to be wired was malfunctioning explaining why a wire was missing. In another case, the technician may have hard wired the fan to overcome a missing make-up air configuration. In these cases, the data from the discrepancies is stored in the database and useful for analytics. In the prior example, while the thermostat may be calling to turn the fan off, if it is hard wired it is always on. Therefore the energy savings will not track expectations. Knowing it is hard wired (even if there is a valid reason, such as for make-up air compensation) allows that analytics around energy savings in other parts of the system to gain this knowledge.

FIG. 6C shows example process of configuring and training the system as well as how it is used in the field and how identification is done. A database of known devices with photos of expected installation configurations is kept 760 for reference and for validating installations. When the system is initially setup, the training 700 of the system is done through taking photographs of the necessary installation connectors, wiring, switches and settings. These images are repeatedly scanned in various sizes and angles to train the image recognition module of the system to find the appropriate components that are to be verified.

If a new HVAC unit is to be installed in the field, a training of the system takes place so that the system has the reference images on hand in the database to validate in-field installations done by subsequent technicians. Images of connectors, dip-switches, wiring pins and pots, or switches are used. The system can recognize wires that are present or not present, wire color, as well as switches that are set to an on or off position. The initial training of the system is done by a training technician in the lab who is knowledgeable with the system training. In addition to recognizing the components, the position of where known sensors and controls are to be wires is taught to the system by annotating each of the components that may be used.

When a new site is to be installed, a site survey 701 takes place and gathers information about what is on the site 705 this goes into a database 710 containing site specific information about existing equipment including sensors and controls. Some of this equipment may be replaces as part of the installation but some may be reused.

As part of the purchase or sign-up process 715 a list of equipment 720 to be installed on the site is added as a bill of materials 725 and installation plan for the site.

When the technician arrives on the site 730 they confirm the information site survey and installation BOM 735. If the combination of new HVAC and components to be installed or attached and configured is a known configuration 740 then the system gathers reference photos 745 from the known configuration tables in the database 760 to be used for the installation.

The technician can then complete the installation using the reference photos as a guide 750.

The technician is then asked to take photographs by the system 755 of key areas to be verified against the reference photos and the system does a photographic match 785 as it has been trained for the configuration at hand.

If the photos are a match 790 then the system may do further connection tests 793 where applicable. For example, if some equipment can be remotely controlled the system may initiate commands to test the functionality and ask the technician to confirm the operations. If these tests pass then the installation is approved 795 and the technician can leave the site with the installation completed.

If the automation tests are unsuccessful 793 or if the photos taken do not match 785 then the technician continues with the installation procedure 750 where the installation may be changed. Once again, the technician can refer to the reference photos to gain insight into where the installation went wrong.

If the configuration is not known 740 then the technician can still complete the installation without a guide 765. No reference photos will be available or only some partial photos may be available. For example, if the HVAC unit being installed is a known model but there is a new sensor, the configuration data can still be used as well as the reference photos for the installation for all but the new sensor being added.

Once the installation is completed, 770 the technician takes pictures of the installation. The system will request pictures or will extract information that was missing to enhance or supplement the reference photos kept for the installation HVAC type and known sensors and controls. Once again, if only a new sensor is being added, the technician may be asked to take pictures of only the wiring needed for that sensor.

Typically the configuration of all equipment is done in the initial training 700 of the system. This initial training 700 does not have to be a one time process, but rather, as new equipment is discovered or added, training technicians can do sample installs in the lab environment training the system to add the new components.

Further, if the technician on site encounters some new equipment that they are not comfortable installing they may abort the installation, call for help, or do a partial installation if the system components in question are not mandatory or essential for safe operation. It is expected that in most cases new equipment may be discovered as part of the site survey 701 and can be used to either sent an experience technician on site 710 for that particular install or to have someone in the lab environment train the system 700 with the new equipment before the technician is deployed.

In either case, the system performs the photographic matching 785 of the installation and if the photos don’t match the system will allow the technician to redo the installation or adapt it 750 but the technician can also override 791 the system and continue with the testing.

The next step is any automated connection tests by the system where applicable 793 and finally the installation is approved 795

FIG. 7 shows a sample table of sensor types by HVAC models that may be stored in the tagged photo storage 185. The table entry 800/860 shows a particular model, and the HVAC model ABC is show in the front for illustration purposes. Sensors are listed in the first column 820 with a yes/no column 830 for if they are supported or not by the device in column 2. A location annotation 840 is in column three and finally a wiring color 850 is in column 4. Reference images 810 are kept for each row so that the system can detect and verify the installation even if slightly askew or resized. These images 810 and the table can be provided to the installer app as needed to perform image recognition and connection/setting identification on the mobile device on site. The table provided can also be embedded in the reference image 810 as metadata, for example as a comma separated value (CSV) table or otherwise.

Going row by row now the occupancy sensor 860 is supported and is attached to wiring block 1 on pins 2,3,4. The wiring color is red for pin 2, black for pin 3, and purple for pin 4. Similar wiring and configuration settings are identified for other devices. Based on the devices used and the various configurations, dip switch or rotary switch settings may be necessary and similar tables and data can indicate the needed positions. It will be understood by those of skill in the art that while examples using HVAC devices are utilized but that the same system can be adapted and used for any temperature control-based systems including heating, water heaters, and other such systems. Here, the expected wiring configuration can also be seen in that the red wire of the occupancy sensor should be connected to pin 2 in wiring block 1 and so forth. However, sometimes the wire color may not be the same as in the table, but the location of the wires on both ends match. This can best be seen in the context of the connection between the controller and the thermostat where, for example if the Y1 connector on both the thermostat and controller sides is a blue wire, the software would know that the Y1 terminal is connected with a common wire. If instead both Y1 terminals are connected with a red wire, then the common wire is a different color. However, if the Y1 terminal uses a red wire on the thermostat and the Y1 terminal on the controller uses a blue wire, the software would identify an exception and issue an alert because the matched pairs of connectors (e.g. Y1 on the thermostat and the controller) are not connected properly. Thus, the color of the wire may not particularly matter, only that the color matches. Further, by “color” this includes various patterns in that a black striped wire is considered a different color than a solid black wire as but one example.

While the disclosure is susceptible to various modifications, and alternative forms, specific examples thereof have been shown in the drawings and are herein described in detail. Is should be understood however that the disclosure is not limited to the particular forms or methods or embodiments disclosed.

What is claimed is:

1. An installation verification system for a facility comprising:
software executing on a computer;
said software configured to receive image data of one or more components of an HVAC system installation comprising HVAC system components including an HVAC unit and at least one sensor;
said software identifying a plurality of features in the image data related to wiring connections and/or switch settings by correlating the image data to example image data stored in a storage using image recognition, the example image data associating relative positions of items related to wiring connections and/or switch settings on similar HVAC system installations including similar HVAC units and sensors;
wherein based on the correlation of the image data to the example image data as determined by image recognition, the software identifies actual settings comprising actual wiring settings and/or actual switch settings associated with the HVAC system installation;
said software determining an installation configuration based on the HVAC system components associated with the facility, the HVAC system components identifying the HVAC unit and the plurality of sensors, the installation configuration identifying one or more expected settings comprising one or more expected wiring connections and/or expected switch settings for the HVAC system components;
said software comparing the expected settings to the actual settings to determine if the expected and actual settings match and said software generating an alert if there are expected and actual settings that do not match, wherein the alert is indicative of where the expected and actual settings do not match.

2. The system of claim 1, wherein the HVAC system components are identified by said software in the image data.

3. The system of claim 1, wherein the software receives data identifying the HVAC system components in order to determine the expected wiring connections and/or expected switch settings.

4. The system of claim 1, wherein the alert includes a display with one or more visual identifications of at least one corrective action to remedy expected and actual settings which do not match.

5. The system of claim 1, further comprising said software receiving additional image data related to the corrective action and said software uses the image recognition to determine if the at least one corrective action has been performed.

6. The system of claim 1, wherein the actual wiring settings are identified by determining wire color for a plurality of wired connection of a pair of HVAC system components.

7. The system of claim 6, wherein the pair of HVAC system components includes a plurality of matched pairs of wired connections and the software comparing the expected settings to the actual settings determines the match if wire colors match for the matched pairs of wired connections.

8. An image capture system for validation of HVAC device configuration at a site comprising:
software executing on a computer;
said software configured to obtain site information which identifies HVAC devices for connection at the site, each HVAC device comprising a plurality of wire connectors and wherein a plurality of pairs of wire connectors, one on each HVAC device, are matched by said software to identify matched pairs of connectors for connection at the site;
said software configured to obtain image data associated with wire connectors of two HVAC devices;
said software associating the image data with a corresponding HVAC device identification and said software comparing the image data to stored image data correlated to the HVAC device identification using image recognition to identify wire connections in the image data;
said software determining if the matched pairs of connectors are each connected by a common wire and said software identifying one or more incorrect connections between matched pairs in order to determine if connection of the two HVAC devices is complete and wherein said software generates an alert based on the incorrect connections and determining that the connection of the two HVAC devices is incomplete.

9. The system of claim 8, wherein the alert identifies the incorrect connections if the software determines the connection of the two HVAC devices is incomplete.

10. The system of claim 8, wherein said software is configured to direct placement of the camera relative the wire connectors of each of the two HVAC devices to obtain the image data.

11. The system of claim 8, wherein the image recognition identifies a plurality of wire colors to match each wire color to one of the matched pairs of connectors such that each wire color corresponds to one of the common wires of the matched pairs.

12. The system of claim 8, wherein the image recognition further identifies and verifies one or more wire connections on one of the HVAC devices which relate to a sensor based comparing the image data to stored image data which identifies wires connected to the one or more wire connections related to the sensor.

13. The system of claim 12, wherein the sensor is identified by the site information and the software determines that connection of the two HVAC devices is complete at least based in part on identifying the wires connected to the one or more wire connections related to the sensor.

14. The system of claim 8, wherein based on the site information the software determines that connection of the two HVAC devices is complete based on identifying one or more connections of one or more of the two HVAC devices which are not connected.

15. A method of using image recognition to validate HVAC device installation at a site comprising:
providing software executing on a computer said software configured to preform the steps of:
obtaining images of two HVAC devices;
comparing the images with a stored image associated with a HVAC device identifier correlated to each HVAC device, the comparison including image recognition which identifies one or more tags in the stored image which are correlated to the images in order to recognize a plurality of wire connections of the two HVAC devices;
identifying matched pairs of wire connections associated with the two HVAC devices and identifying a common wire connected between the matched pairs;
comparing the matched pairs to an expected wiring configuration associated with the two HVAC devices determine if the matched pairs are connected according to the expected wiring configuration in order to validate correct installation of the two HVAC devices and wherein if the comparing identifies incorrect wiring of one or more of the matched pairs, said software generating an alert.

16. The method of claim 15, wherein identifying a common wire includes identifying wire color in each image the two HVAC devices to correlate that wire color with a corresponding one of the matched pairs.

17. The method of claim 15, wherein the expected wiring configuration identifies wire connections in each of the two HVAC devices which should be wired together and the comparing the matched pairs determines if the wire connections in each of the two HVAC devices are the same connections as the matched pairs.

18. The method of claim 15, further comprising the step of said software identifying and verifying one or more wire connections on one of the HVAC devices which relate to a sensor based comparing the image data to stored image data which identifies wires connected to the one or more wire connections related to the sensor.

19. The method of claim 15, wherein based on the site information the software determines that connection of the two HVAC devices is complete based on identifying one or more connections of one or more of the two HVAC devices which are not connected.
